(19) United States
(12) Patent Application Publication
(10) Pub. No.: US 2026/0153794 A1
(43) Pub. Date: Jun. 4, 2026

(54) MULTIFUNCTIONAL PROJECTION APPARATUS

(71) Applicant: OXTI Pte Ltd, Singapore (SG)

(72) Inventor: YU-LIN LIN, Singapore (SG)

(21) Appl. No.: 18/969,233

(22) Filed: Dec. 4, 2024

(51) Int. Cl. G03B 21/20; G03B 21/54; H04R 1/02

(52) U.S. Cl. CPC G03B 21/2053; G03B 21/54; H04R 1/025; H04R 2499/15

(57) ABSTRACT

A multifunctional projection apparatus includes a projection portion including a projection light source and a projection screen; a support portion, the support portion arranged at one side of the projection portion, a supporting frame being arranged between the projection portion and the support portion, two ends of the supporting frame being respectively connected to the projection portion and the support portion; a control circuit arranged in the projection portion and electrically connected to the projection light source and the projection screen; a sounding module arranged in the projection portion; and a wireless charging module arranged on the support portion. The supporting frame can be used to adjust the relative position between the projection portion and the support portion, and the sounding module is operable to issue sounding, while the wireless charging module may carry out electrical charging, so that multiple functions are achieved.

### BACKGROUND OF THE INVENTION

### Technical Field of the Invention

The present invention relates generally to a projection apparatus, and more particularly to a multifunctional projection apparatus.

### Description of the Prior Art

A projection apparatus refers to a display device that uses a projection tube or liquid crystal panel having a special structure, together with an optical system, to magnify and project an image onto a projection screen.

For example, Taiwan Patent No. I831031 discloses “projection equipment”, which includes a projection device, a reflective element and an image capture device. The projection device is adapted to project an image beam to form a projected image. The reflective element is arranged on the projection device and has a reflective surface. The image capture device is arranged on the projection device and has an image capture end. The image capture end faces the reflective surface. The reflective surface is suitable for reflecting the projected image to the image capture end.

However, the conventional projection device only has a single function and no other functions are included, so that the function of use is generally limited and cannot meet people’s needs for multiple functions. Therefore, the existing projection devices need to be improved to meet modern people’s needs.

### SUMMARY OF THE INVENTION

To achieve the above objective, the present invention provides a multifunctional projection apparatus, which comprises: a projection portion, the projection portion comprising a projection light source and a projection screen; a support portion, the support portion being arranged at one side of the projection portion, a supporting frame being arranged between the projection portion and the support portion, two ends of the supporting frame being respectively connected to the projection portion and the support portion; a control circuit, the control circuit being arranged in an interior of the projection portion, the control circuit being electrically connected to the projection light source and the projection screen; a sounding module, the sounding module being arranged in the interior of the projection portion; and a wireless charging module, the wireless charging module being arranged on the support portion.

In the above apparatus, the projection portion comprises a signal receiver module, and the signal receiver module is electrically connected to the control circuit.

In the above apparatus, the supporting frame comprises a first supporting rod and a second supporting rod, and a pivotal axle is arranged between the first supporting rod and the second supporting rod.

In the above apparatus, the control circuit comprises a motor and a rotation axle, the motor being connected to the rotation axle, and the rotation axle is connected to the projection screen.

In the above apparatus, the sounding module comprises a sound box, a speaker, or a loud speaker.

The supporting frame functions for adjusting the relative position between the projection portion and the support portion, and the sounding module functions for issuing sounding, and the wireless charging module functions for carrying out electrical charging, and as such the purpose of having multiple functions is achieved.

### BRIEF DESCRIPTION OF THE DRAWINGS

FIG. 1 is an exploded view showing a multifunctional projection apparatus according to the present invention.

FIG. 2 is a perspective view showing the multifunctional projection apparatus according to the present invention.

FIG. 3 is a side elevational view showing the multifunctional projection apparatus according to the present invention.

FIG. 4 is a schematic view illustrating light emission of the multifunctional projection apparatus according to the present invention.

FIG. 5 is a schematic view illustrating forward/backward movement of a projection screen according to the present invention.

FIG. 6 is a schematic view illustrating sound generation of a sounding module according to the present invention.

FIG. 7 is a schematic view illustrating ascending/descending of the projection screen according to the present invention.

FIG. 8 is a schematic view illustrating wireless charging according to the present invention.

FIG. 9 is a schematic view illustrating leftward/rightward movement of the projection screen according to the present invention.

FIG. 10 is a partly block diagram of the multifunctional projection apparatus according to the present invention.

FIG. 11 is a schematic view illustrating a penetration slot according to the present invention.

### DETAILED DESCRIPTION OF THE PREFERRED EMBODIMENTS

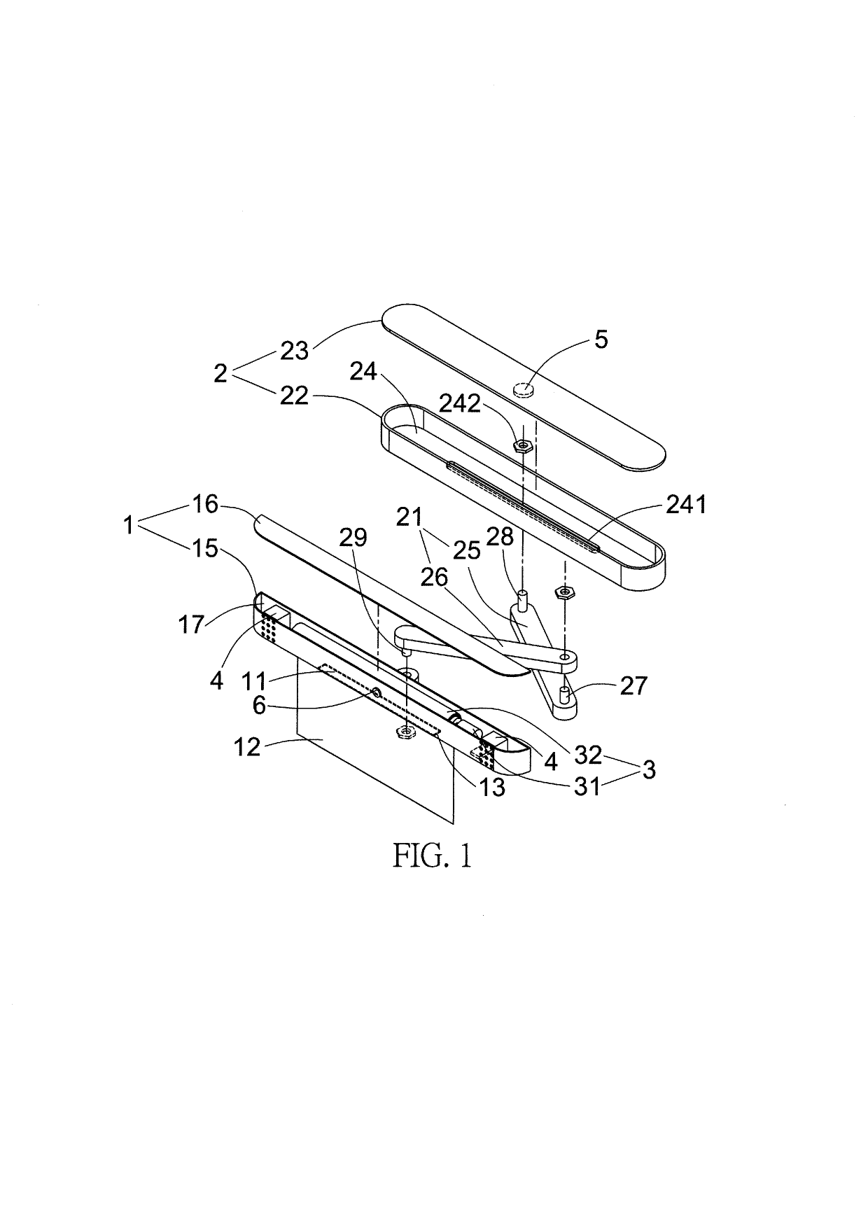

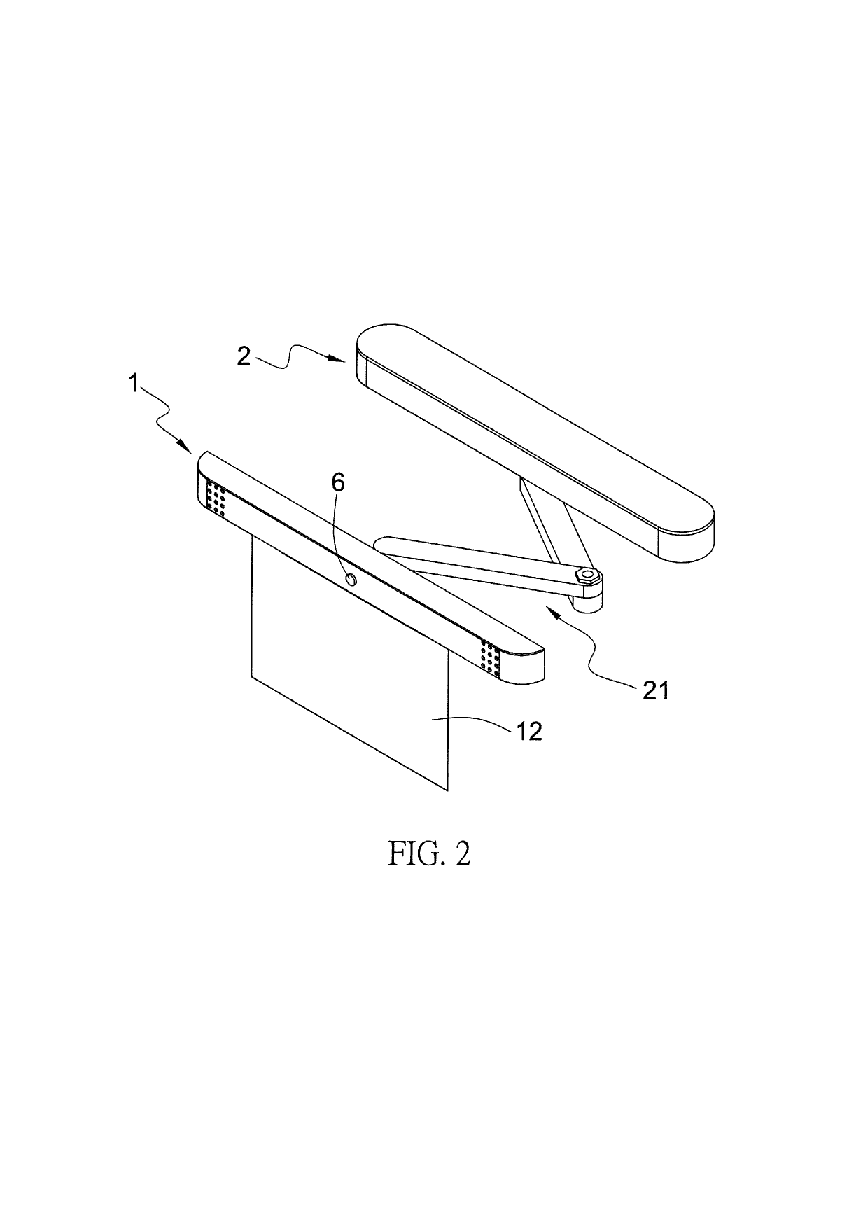

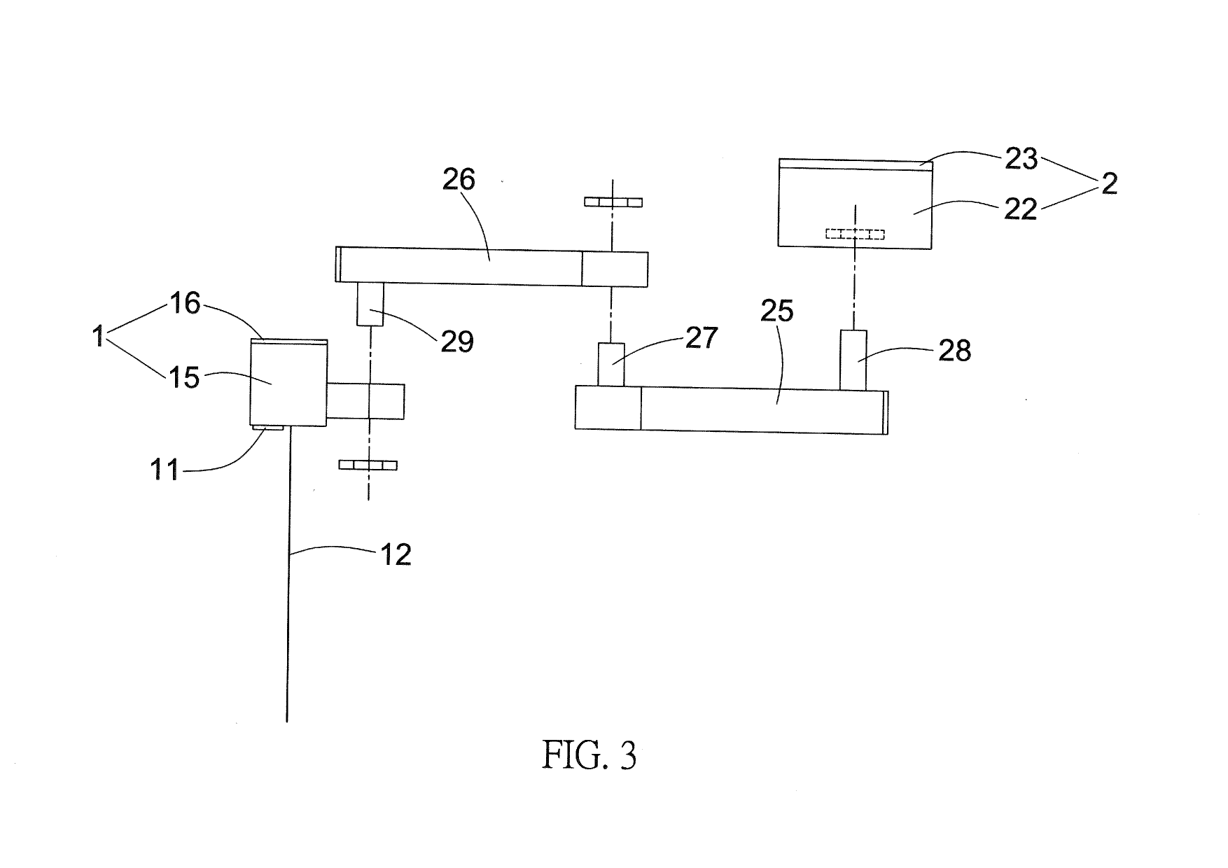

Referring to FIGS. 1, 2, and 3, the present invention provides a multifunctional projection apparatus, which comprises:

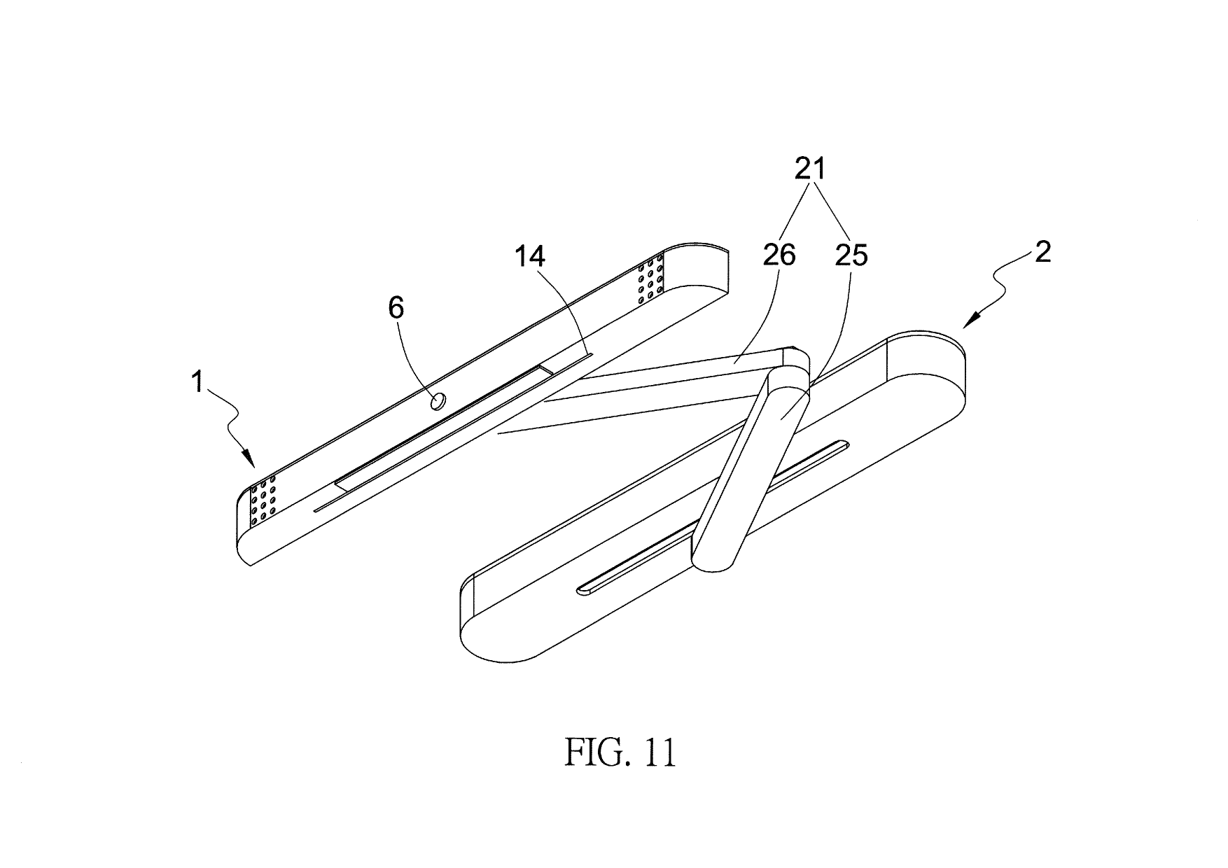

a projection portion 1, wherein the projection portion 1 comprises a projection light source 11 and a projection screen 12, and the projection portion 1 is formed with an insertion slot 13 and a penetration slot 14 (shown in FIG. 11), wherein the insertion slot 13 is provided to receive the projection light source 11 to dispose therein and the penetration slot 14 is provided to receive the projection screen 12 to penetrate therethrough; the projection portion 1 comprises a first casing 15 and a first cover 16, and the first casing 15 and the first cover 16 jointly define a first receiving space 17, wherein the projection light source 11 can be a light bulb based light source, a light-emitting diode (LED) based light source, or a laser based light source;

a support portion 2, wherein the support portion 2 is arranged at one side of the projection portion 1, and a supporting frame 21 is arranged between the projection portion 1 and the support portion 2, two ends of the supporting frame 21 being respectively connected to the projection portion 1 and the support portion 2, wherein the support portion 2 comprises a second casing 22 and a second cover 23, and the second casing 22 and the second cover 23 jointly define a second receiving space 24, and the supporting frame 21 comprises a first supporting rod 25 and a second supporting rod 26, and a pivotal axle 27 is arranged between the first supporting rod 25 and the second supporting rod 26, wherein the first supporting rod 25 is rotatably connected by a first connection axle 28 to the support portion 2, and the second supporting rod 26 is rotatably connected by a second connection axle 29 to the projection portion 1; the second casing 22 of the support portion 2 is formed with a slide channel 241, the slide channel 241 being provided to receive the first connection axle 28 of the first supporting rod 25 to extend therethrough to screw into and be fastened with a nut 242, so that the first supporting rod 25 is movable along the slide channel 241 to enable movement (leftward/rightward movement) of the supporting frame 21 relative to the support portion 2;

a control circuit 3, wherein the control circuit 3 is arranged in an interior of the projection portion 1, and the control circuit 3 is electrically connected to the projection light source 11 and the projection screen 12, wherein the control circuit 3 can be a light-source control circuit (not shown), and the light-source control circuit may be a light-emitting diode control circuit, and the light-emitting diode control circuit is configured to control a light-emitting diode based light source to emit or stop emitting light; the light-source control circuit can be a laser driver, and the laser driver is configured to control a laser based light source to emit or stop emitting light; and further, the control circuit 3 may comprise a motor 31 and a rotation axle 32, wherein the motor 31 is connected to the rotation axle 32, and the rotation axle 32 is connected to the projection screen 12, wherein the control circuit 3 controls the motor 31 and the motor 31 driving the rotation axle 32 to rotate so that the rotation axle 32 rolls up or lowers down the projection screen 12;

a sounding module 4, wherein the sounding module 4 is arranged in the interior of the projection portion 1, wherein the sounding module 4 can be a sound box, a speaker, or a loud speaker, and the sounding module 4 is electrically connected to the control circuit 3, and the control circuit 3 comprises a sounding control circuit (not shown), and the sounding control circuit can be a sound box control circuit, the sound box control circuit controlling the sound box to generate sound or stop generating sound; the sounding control circuit may alternatively be a speaker control circuit, the speaker control circuit controlling a speaker to generate sound or stop generating sound; the sounding control circuit can be a loud speaker control circuit, the loud speaker control circuit being configured to control the loud speaker to generate or stop generating sound; and

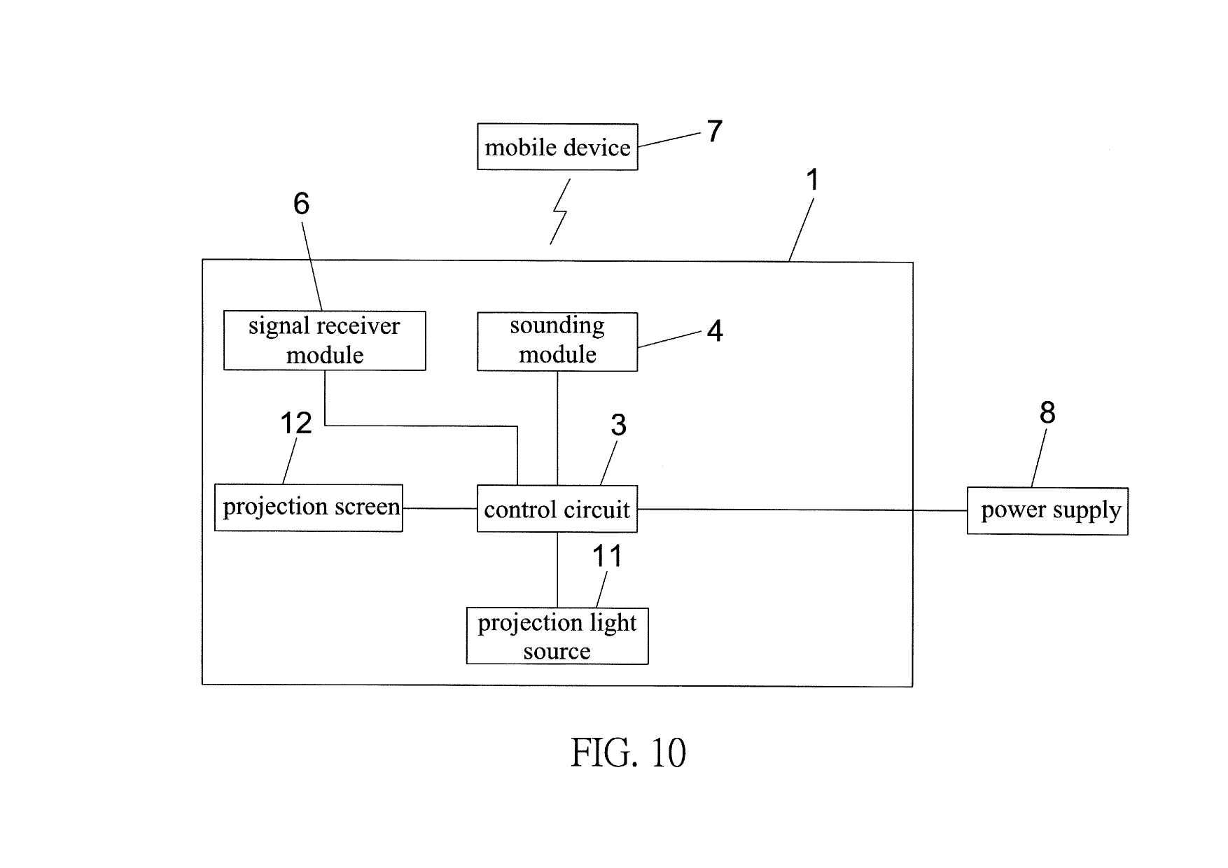

a wireless charging module 5, wherein the wireless charging module 5 is arranged in the support portion 2 (such as being arranged in an interior of the support portion 2, but not limited thereto), wherein the wireless charging module 5 is in connection with a power supply 8 (shown in FIG. 10), wherein the power supply 8 is an internal power supply or an external power supply, the internal power supply being a battery or a capacitor, the external power supply being a mobile or portable power supply or an alternate-current power supply of an electric main (such as being connected through a power cable plugged into a wall socket to receive a supply of the alternate-current power), so that the power supply 8 (shown in FIG. 10) supplies electrical power and in electrical connection with the control circuit 3, wherein the wireless charging module 5 utilizes near-field induction (that is inductive coupling, without the need for wire connection) to transmit electrical power from the power supply 8 to a device to be charged.

In the above apparatus, the projection portion 1 may further comprises a signal receiver module 6, and the signal receiver module 6 is electrically connected to the control circuit 3. The signal receiver module 6 can be a wireless signal receiver module, which is capable of receiving a wireless signal. The wireless signal receiver module may alternately be a Bluetooth module or a Wi-Fi module, and the wireless signal can thus be a Bluetooth signal or a Wi-Fi signal. The wireless signal can be transmitted from a mobile device 7 (shown in FIG. 10), and the mobile device 7 can be a mobile phone or a remote control.

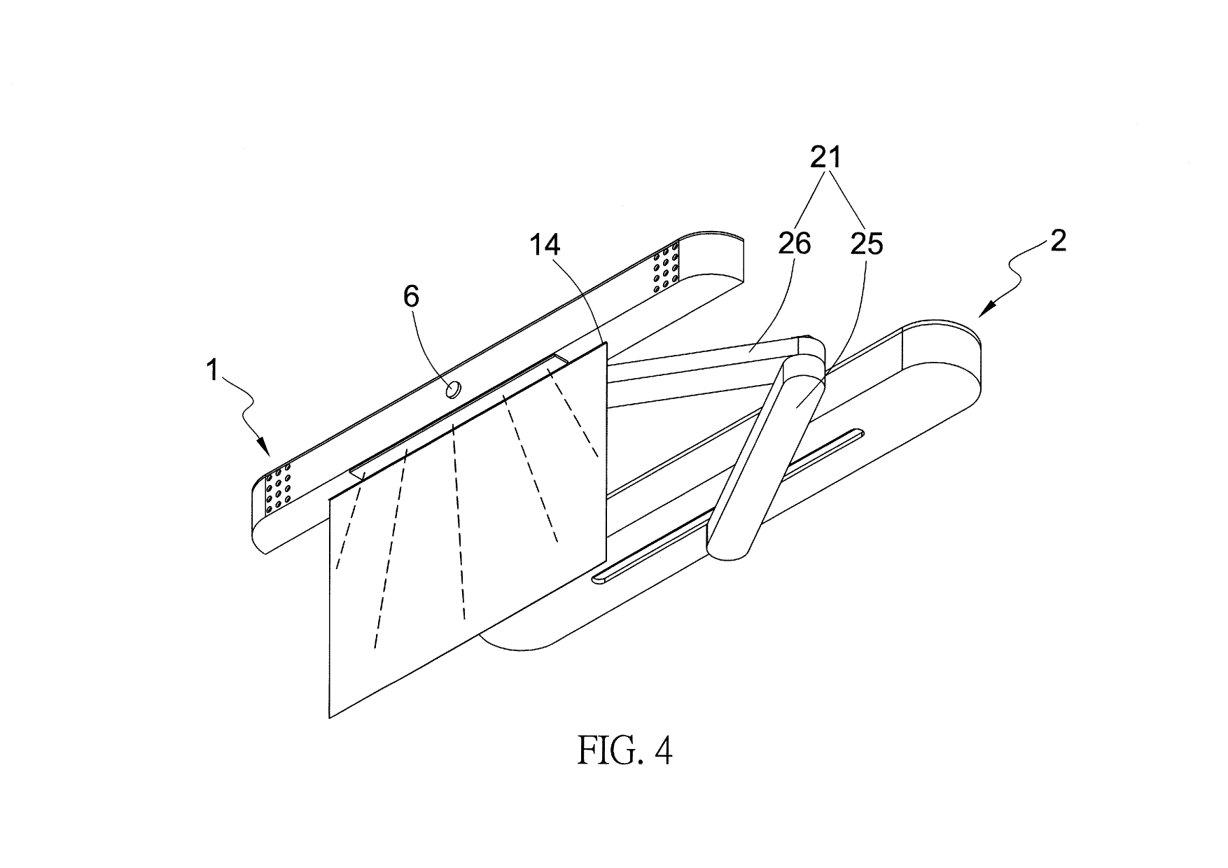

Referring to FIGS. 1, 4, and 10, after the power supply 8 is supplied with electrical power, the control circuit 3 controls the projection light source 11, such that the projection light source 11 emits light toward the projection screen 12 or stops emitting light in order to fulfill the function of image projection. Further, the mobile device 7 may be operated to remotely control the projection light source 11, meaning the mobile device 7 transmits a wireless signal to the signal receiver module 6 of the projection portion 1, and the control circuit 3 controls the projection light source 11 to emit or stop emitting light according to the wireless signal.

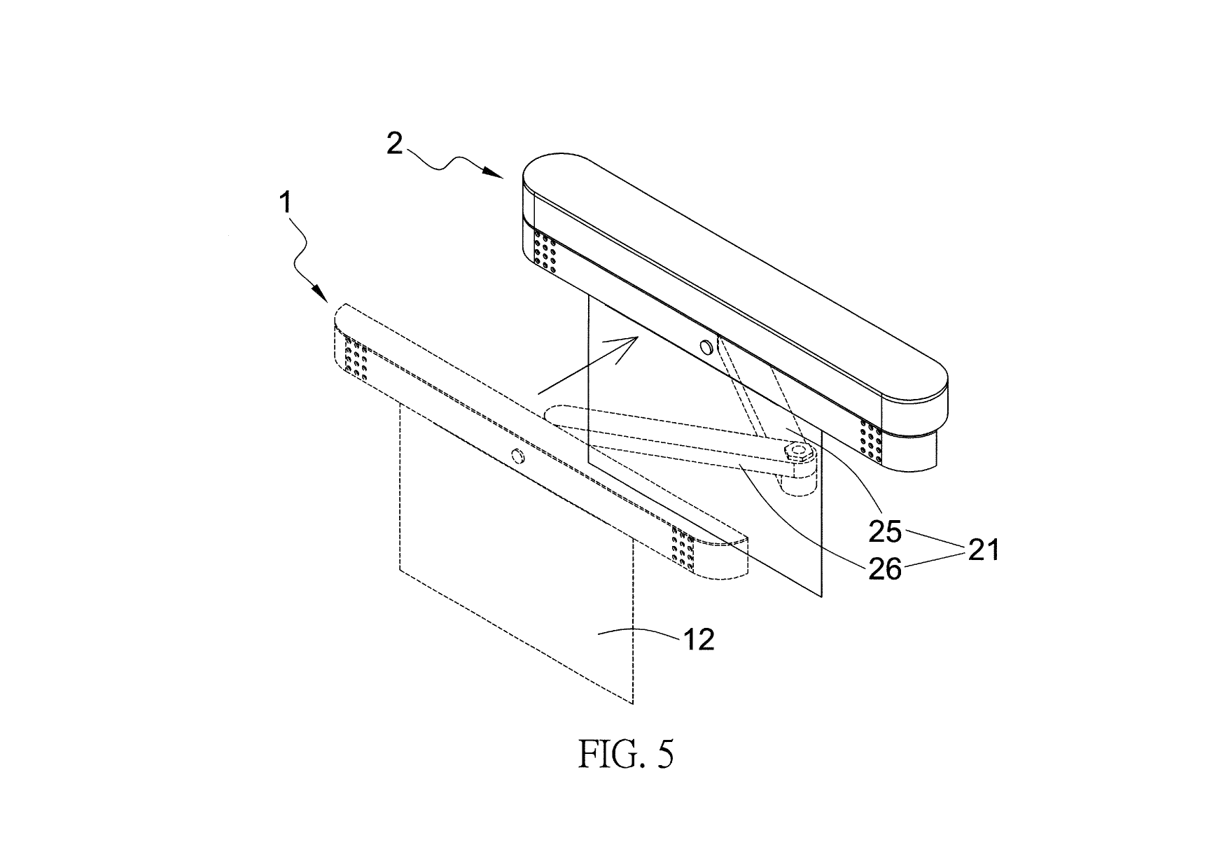

Referring to FIGS. 1 and 5, the pivotal connection between the first supporting rod 25 and the second supporting rod 26 of the supporting frame 21 allows the projection portion 1 to move (frontwards/rearwards) relative to the support portion 2 so as to cause the projection screen 12 to move frontwards/rearwards.

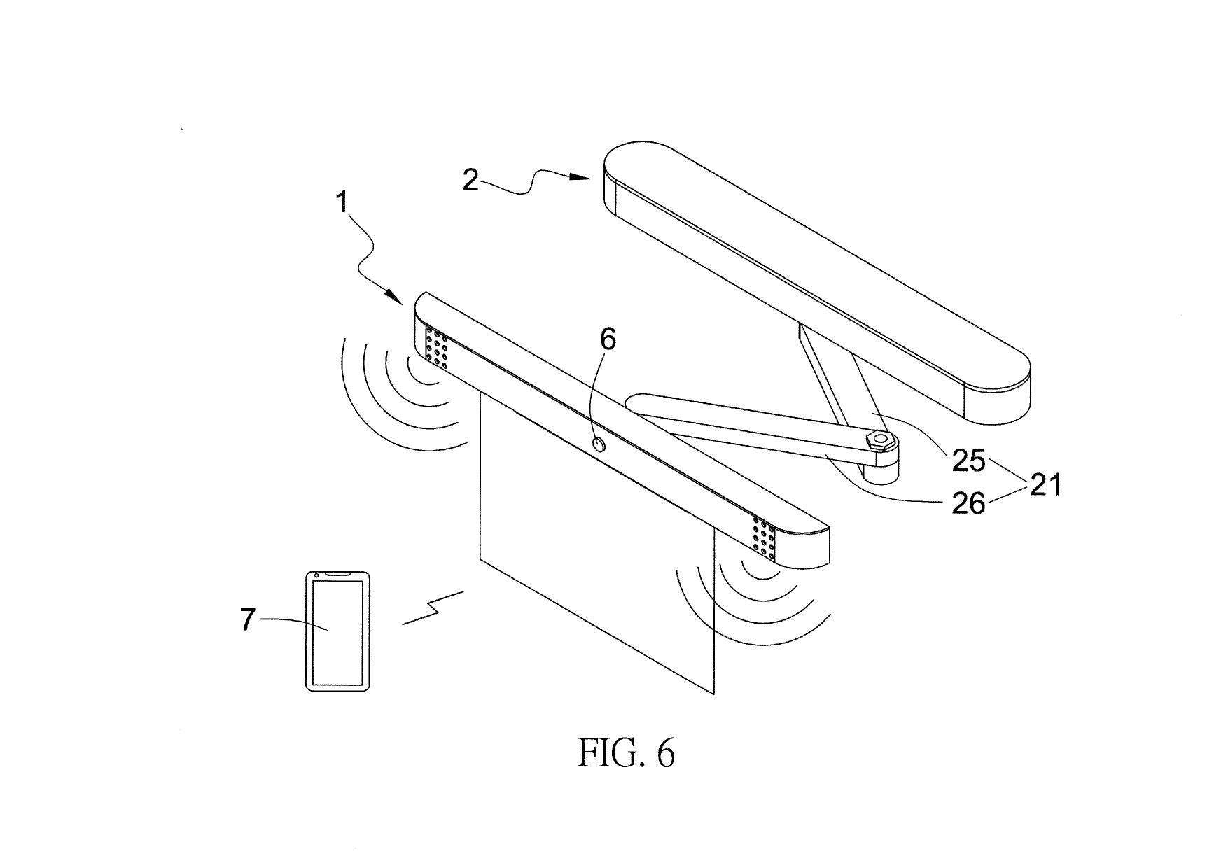

Referring to FIGS. 1, 6, and 10, after the power supply 8 is supplied with electrical power, the control circuit 3 controls the sounding module 4, such that the sounding module 4 generates or stop generating sounds in order to fulfill the function of sounding. Further, the mobile device 7 may be operated to remotely control the sounding module 4, meaning the mobile device 7 transmits a wireless signal to the signal receiver module 6 of the projection portion 1, and the control circuit 3 controls the sounding module 4 to generate or stop generating sounding according to the wireless signal.

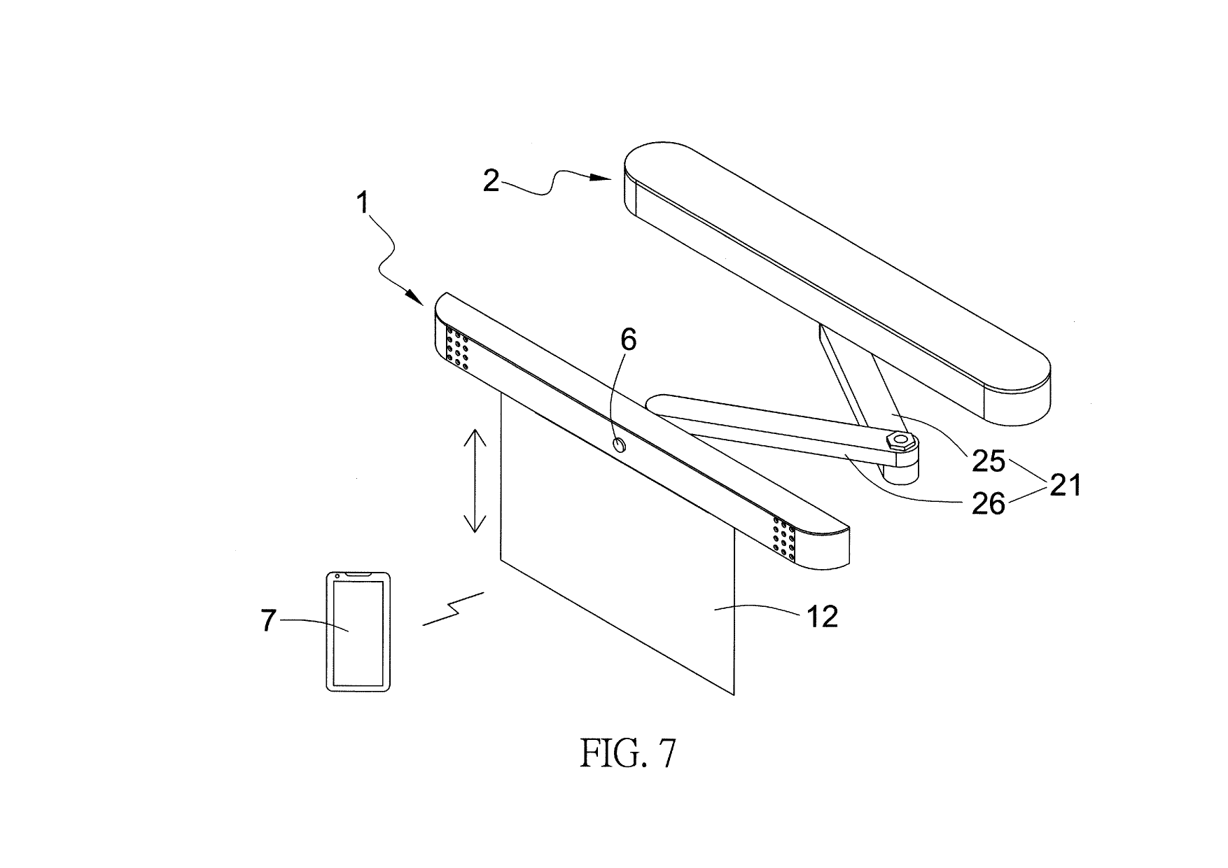

Referring to FIGS. 1, 7, and 10, after the power supply 8 is supplied with electrical power, the control circuit 3 controls the projection screen 12, such that the projection screen 12 is rolled up or lowered down in order to fulfill the function of screen ascending/descending. Further, the mobile device 7 may be operated to remotely control the projection screen 12, meaning the mobile device 7 transmits a wireless signal to the signal receiver module 6 of the projection portion 1, and the control circuit 3 controls the motor 31 according to the wireless signal to have the motor 31 drive the rotation axle 32 to rotate to have the rotation axle 32 roll up or lower down the projection screen 12.

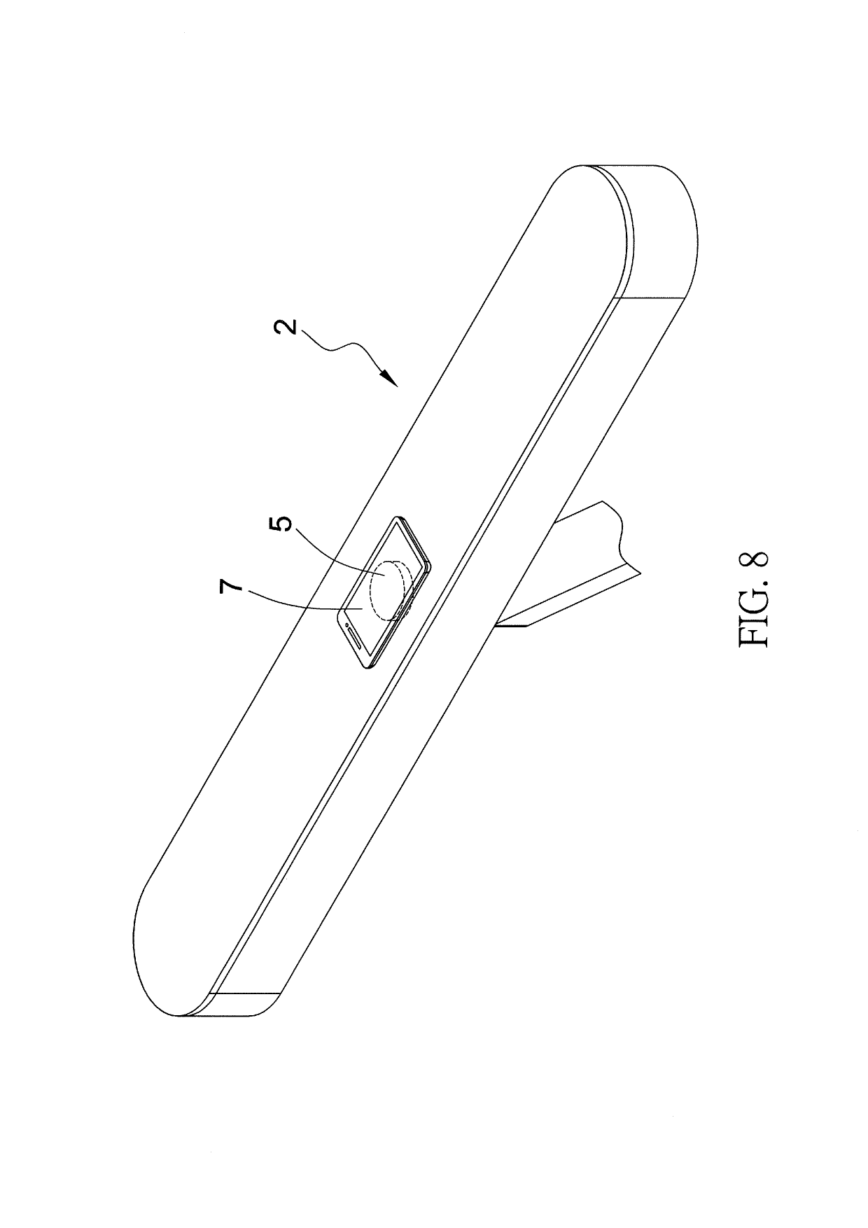

Referring to FIGS. 1 and 8, the wireless charging module 5 is used to carry out wireless charging to a device to be changed, such as wireless charging to the mobile device 7.

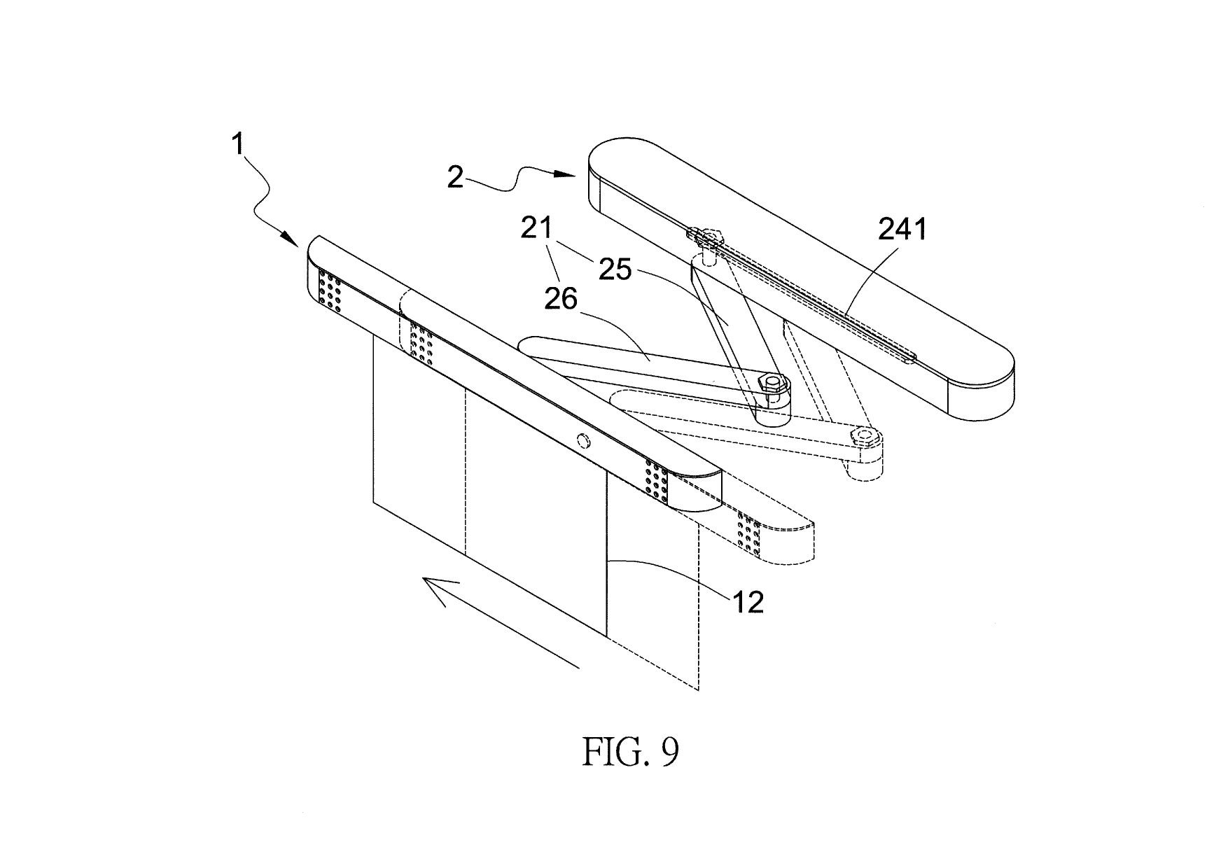

Referring to FIGS. 1 and 9, the first supporting rod 25 is movable along the slide channel 241 so that the supporting frame 21 is moved (leftwards/rightwards) relative to the support portion 2, and the supporting frame 21 drives the projection portion 1 to move (leftwards/rightwards) relative to the support portion 2 to thereby cause the projection screen 12 to move leftwards/rightwards.

The present invention utilizes the supporting frame 21 to adjust the relative position between the projection portion 1 and the support portion 2, and uses the sounding module 4 to issue sounding and the wireless charging module 5 to carry out electrical charging, so as to achieve the purpose of having multiple functions.

What is claimed is:

1. A multifunctional projection apparatus, comprising:
a projection portion, the projection portion comprising a projection light source and a projection screen;
a support portion, the support portion being arranged at one side of the projection portion, a supporting frame being arranged between the projection portion and the support portion, two ends of the supporting frame being respectively connected to the projection portion and the support portion;
a control circuit, the control circuit being arranged in an interior of the projection portion, the control circuit being electrically connected to the projection light source and the projection screen;
a sounding module, the sounding module being arranged in the interior of the projection portion; and
a wireless charging module, the wireless charging module being arranged on the support portion.

2. The multifunctional projection apparatus according to claim 1, wherein the projection portion comprises a signal receiver module, and the signal receiver module is electrically connected to the control circuit.

3. The multifunctional projection apparatus according to claim 1, wherein the supporting frame comprises a first supporting rod and a second supporting rod, and a pivotal axle is arranged between the first supporting rod and the second supporting rod.

4. The multifunctional projection apparatus according to claim 1, wherein the control circuit comprises a motor and a rotation axle, the motor being connected to the rotation axle, and the rotation axle is connected to the projection screen.

5. The multifunctional projection apparatus according to claim 1, wherein the sounding module comprises a sound box, a speaker, or a loud speaker.
